(19) United States
(12) Patent Application Publication
(10) Pub. No.: US 2003/0023794 A1
(43) Pub. Date: Jan. 30, 2003

(54) Cache coherent split transaction memory bus architecture and protocol for a multi processor chip device

(76) Inventors: Padmanabha I. Venkitakrishnan, Sunnyvale, CA (US); Shankar Venkataraman, Danville, CA (US); Paul Keltcher, Sunnyvale, CA (US); Stuart C. Siu, Castro Valley, CA (US); Stephen E. Richardson, Los Altos, CA (US); Gary Lee Vondran JR., San Carlos, CA (US)

Correspondence Address: HEWLETT-PACKARD COMPANY, Intellectual Property Administration, P.O. Box 272400, Fort Collins, CO, 80527-2400, US

(21) Appl. No.: 09/916,598

(22) Filed: Jul. 26, 2001

(51) Int. Cl. G06F 13/42

(52) U.S. Cl. 710/105

(57) ABSTRACT

A cache coherent multiple processor integrated circuit. The circuit includes a plurality of processor units. The processor units are each provided with a cache unit. An embedded RAM unit is included for storing instructions and data for the processor units. A cache coherent bus is coupled to the processor units and the embedded RAM unit. The bus is configured to provide cache coherent snooping commands to enable the processor units to ensure cache coherency between their respective cache units and the embedded RAM unit. The multiple processor integrated circuit can further include an input output unit coupled to the bus to provide input and output transactions for the processor units. The bus is configured to provide split transactions for the processor units coupled to the bus, providing better bandwidth utilization of the bus. The bus can be configured to transfer an entire cache line for the cache units of the processor units in a single clock cycle, wherein the bus is 256 bits wide. The embedded RAM unit can be implemented as an embedded DRAM core. The multiple processor integrated circuit is configured to support a symmetric multiprocessing method for the plurality of processor units. The processor units can be configured to provide read data via the bus, as in a case of a read request by one processor when the read data is stored within a respective cache unit of another processor.

### FIELD OF THE INVENTION

The present invention relates generally to system bus architectures. More particularly, the present invention relates to a method and system for a high performance system bus architecture for a multiple processor integrated circuit device.

### BACKGROUND OF THE INVENTION

Computers are being used today to perform a wide variety of tasks. Many different areas of business, industry, government, education, entertainment, and most recently, the home, are tapping into the enormous and rapidly growing list of applications developed for today's increasingly powerful computer devices. Computers have also become a key technology for communicating ideas, data, and trends between and among business professionals. These devices have become so useful and ubiquitous, it would be hard to imagine today's society functioning without them.

Computers operate by executing programs, or a series of instructions, stored in its memory. These programs, and their series of instructions, are collectively referred to as software. Software is what makes the computer devices function and perform useful tasks. The utility of the computer device often hinges upon the speed and efficiency with which the computer executes the software program. As programs have become larger and more complex, the execution speed of the computer becomes one of the dominant factors in the utility of the computer device. These factors have increased the demand for higher performing computer devices and systems.

One conventional methods for increasing computer performance is to increase the clock speed of an included microprocessor. Increased microprocessor clock speeds increases the rate at which program steps and instructions are executed, increasing the speed of the software and the associated applications. However, increases in clock speed has its physical limits. High clock speeds cause heating, noise, switching speed problems, and other such problems within the overall computer system. The simple solution of clock speed increases is running into it's practical limits.

Another prior art method for increasing computer performance is to increase the size and complexity of the microprocessor. As silicon technology has improved and increased the number of transistors available on a single chip, the prevailing design philosophy has been to use the additional transistors to increase the performance of the single processor. This design philosophy has been followed to the point of diminishing returns, with the more complex designs having many tens of millions of transistors. The highly integrated dies tend to be very large and tend to have device fabrication yield problems. Heat dissipation is also a problem.

The above problems led to yet another prior art method for increasing computer system performance, the implementation of multiprocessor systems. Conventional multiprocessor systems include separate chips for the respective processors, a memory controller and an I/O controller. These chips are connected together by an interconnect (bus, crossbar switch, or similar method) on a printed circuit board (PCB). A conventional multiprocessor system typically comprises two processor chips connected to once or more a memory controller chips, one or more I/O control chips, and a bus. The separate components are provided as separate integrated circuit dies, or chips, and mounted on and interconnected to a motherboard or PCB, for example, using standard pins and sockets, flip-chip mounting, wirebond connections, etc.

The conventional multiprocessor systems overcame many of the performance limitations of the single processor systems. For example, instead of exclusively relying on clock speed increases or increasing levels of integration, performance can be increased by dividing software based applications into two or more execution threads and executing them in parallel. However, even the multiprocessor systems have their limitations. One problem with the multiprocessor is the cost of chip pins and the physical limitations of PCB wires limit the datapath width and clock frequency of the interconnect. These limitations decrease the system performance by increasing the memory latency for each processor (in uniprocessor and multiprocessor applications), and the synchronization latency between processors (in multiprocessor applications). Much of the complexity of the current generation of processors is a result of techniques for mitigating the effects of this increased latency on performance.

The implementation of multiprocessor systems within a single die, referred to in the industry as CMP, or Chip Multi-Processor, solves some of the conventional multiprocessor system problems, but others remain. For example, CMP systems reduce the costs of chip pins, the physical limitations of PCB wires, interconnect clock frequencies, are reduced, however, problems with respect to coordination among the multiple processors, efficient load sharing of the software application load, and efficient access to memory remain. Increasing the numbers of processors in prior art CMP systems does not linearly increase the performance of the systems due to the problems inherent in managing multiple processors to solve common problems. Specifically problematic are the memory management overhead problems.

Thus what is required is a solution that provides the advantages of CMP systems with respect to increasing computer system performance, but avoids the problems, such as memory management overhead problems. What is required is a solution that provides an efficient interconnection mechanism for CMP systems having embedded memory. Additionally, what is further required is a CMP system architecture that provides low latency, high throughput operation with efficient management of dedicated processor cache memory and embedded DRAM. The present invention provides a novel solution to the above requirements.

### SUMMARY OF THE INVENTION

The present invention is a high performance system bus architecture for a single chip multiprocessor integrated circuit device. The present invention provides the advantages of CMP systems with respect to increasing computer system performance, but avoids the problems, such as memory management overhead problems. The present invention provides an efficient interconnection mechanism for CMP systems having embedded memory. Additionally, the present invention provides a CMP system architecture that provides low latency, high throughput operation with efficient management of dedicated processor cache memory and embedded DRAM.

In one embodiment, the present invention is implemented as a system bus architecture for a cache coherent multiple processor integrated circuit. The circuit includes a plurality of processor units. The processor units are each provided with a cache unit. An embedded RAM unit is included for storing instructions and data for the processor units. A cache coherent bus is coupled to the processor units and the embedded RAM unit. The bus is configured to provide cache coherent snooping commands to enable the processor units to ensure cache coherency between their respective cache units and the embedded RAM unit. The multiple processor integrated circuit can further include an input output unit coupled to the bus to provide input and output transactions for the processor units.

The bus is configured to provide split transactions for the processor units coupled to the bus, providing better bandwidth utilization of the bus. The bus can be configured to transfer an entire cache line for the cache units of the processor units in a single clock cycle, wherein the bus is 256 bits wide. The embedded RAM unit can be implemented as an embedded DRAM core. The multiple processor integrated circuit is configured to support a symmetric multiprocessing method for the plurality of processor units. The processor units can be configured to provide read data via the bus, as in a case of a read request by one processor when the read data is stored within a respective cache unit of another processor. In this manner, the system bus architecture of the present invention provides the advantages of CMP systems with respect to increasing computer system performance, but avoids the problems, such as memory management overhead problems.

### BRIEF DESCRIPTION OF THE DRAWINGS

The present invention is illustrated by way of example and not by way of limitation, in the Figures of the accompanying drawings and in which like reference numerals refer to similar elements and in which:

FIG. 1 shows a diagram of a CMP system in accordance with one embodiment of the present invention.

FIG. 2 illustrates several system bus transaction phases for a non-split transaction with data transfer in accordance with one embodiment of the present invention.

FIG. 3 shows several bus transaction phases for a split transaction data transfer in accordance with one embodiment of the present invention.

FIG. 4 shows a table of the signal functions of the system bus in accordance with one embodiment of the present invention.

FIG. 5 shows a table of a set of Command Phase Signals in accordance with one embodiment of the present invention.

FIG. 6 shows a table of a set of Reply Phase signals in accordance with one embodiment of the present invention.

FIG. 7 shows a state transition diagram depicting the transitions between the states in accordance with the cache coherency protocols.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to obscure aspects of the present invention unnecessarily.

Embodiments of the present invention are directed towards a high performance system bus architecture for a single chip multiprocessor integrated circuit device. The present invention provides the advantages of CMP systems with respect to increasing computer system performance, but avoids the problems, such as memory management overhead problems. The present invention provides an efficient interconnection mechanism for CMP systems having embedded memory. Additionally, the present invention provides a CMP system architecture that provides low latency, high throughput operation with efficient management of dedicated processor cache memory and embedded DRAM. The present invention and its benefits are further described below.

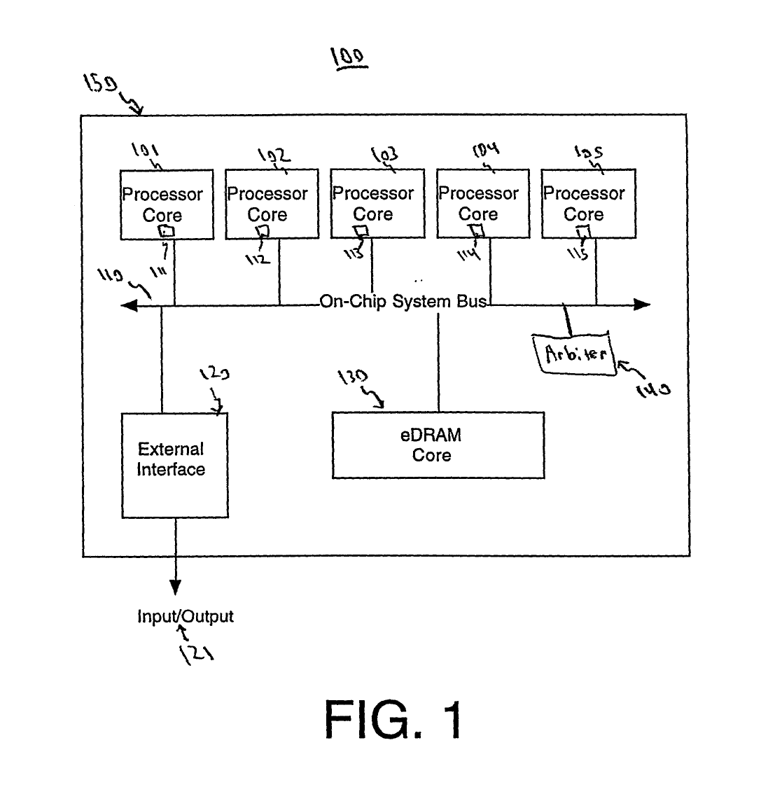

FIG. 1 shows a diagram of a CMP system 100 in accordance with one embodiment of the present invention. As depicted in FIG. 1, CMP system 100 includes processor units 101-105 coupled to a system bus 110. An external interface unit 120, an embedded RAM unit 130, and an arbiter unit 140 are also coupled to bus 110. The components 101-140 are fabricated into a single integrated circuit die 150. In this embodiment, RAM unit 130 is implemented as an embedded DRAM core, processor units 101-105 are implemented as high speed RISC processor cores, preferably MIPS compatible processor cores.

Referring still to system 100 of FIG. 1, the MPOC (Many Processors, One Chip) on-chip system bus 110 is architected to be a high bandwidth and low latency Symmetric Multi-Processing (SMP) type bus for interconnecting a plurality of on-chip microprocessor cores 101-105 and an embedded DRAM (eDRAM) core 130. System 100 is an MPOC, a single-chip community of identical high speed RISC processors surrounding a large common storage area, RAM 130. Each of processors 101-105 has its own clock, cache (e.g., caches 111-115) and program counter. Because each processor is small and simple, it can be made to run very fast at low power.

Embodiments of the system 100 can be targeted for mid to high end embedded applications and e-commerce markets, where CMP system 100 attributes have several qualities that make them attractive. System 100's instruction set architecture supports smaller rather than larger program sizes, i.e. more towards the small RISC style of instruction set and less towards the wide VLIW style. In one embodiement, to speed development and increase customer acceptance, the instruction set is fully compatible with an established standard, MIPS.

Detailed descriptions of the functions, features, transactions and protocol of the CMP system 100 on-chip system bus 110 with their requirements and specifications follow.

On-Chip System Bus Protocol, Transactions, and Signals chip system bus protocols, transactions, and signals for system bus 110 are now described. In the present embodiment, the processor cores 101-105 and the eDRAM core 130 are bus agents issuing transactions to the system bus 110 to transfer data and system information. As used herein, a Bus Agent refers to any device that connects to the system bus 110. A transaction refers to a set of bus activities related to a single bus request. A transaction may contain several phases. A phase refers to a specific set of system bus signals to communicate a particular type of information. In the system bus protocol of the present invention, a particular bus agent can have one or more of several roles in a transaction.

In the present embodiment, the roles a particular bus agent can implement are as follows:

Requesting Agent: The agent that issues the transaction.

Destination Agent: The agent that is addressed by the transaction.

Snooping Agent: A caching bus agents that observes (“snoops”) bus transactions to maintain cache coherency.

Replying Agent: The agent that provides the reply to the transaction. Typically the addressed agent.

In the present embodiment, each system bus 110 transaction has several phases that include some or all of the following phases:

Arbitration Phase: No transaction can be issued until the bus agent owns the bus. This phase is needed in a transaction only if the agent that wants to drive the transaction does not already own the bus.

Command Phase: This is the phase in which the transaction is actually issued to the bus. The requesting agent (bus owner) drives the command and the address in this phase. All transactions must have this phase.

Snoop Phase: This is phase in which cache coherency is enforced. All caching agents (snoop agents) inform the bus if the destination address references a Shared (S) or Modified (M) cache line. All memory transactions have this phase.

Reply Phase: The reply agent, which is the destination device addressed during the command phase, drives the transaction reply during this phase. All transactions have this phase.

Data Phase: The reply agent drives or accepts the transaction data, if there is any. Not all transactions have this phase.

In the present embodiment, the system bus 110 protocol supports the following type of data transfers:

Request Initiated Data Transfer: The request agent has write data to transfer.

Reply Initiated Data Transfer: The reply agent provides the read data to the request agent.

Snoop Initiated Data Transfer: A hit to a modified line happened in a bus agent during the snoop phase, and that agent is going to drive the modified data to the system bus 110. This is also a case of implicit writeback because the addressed memory agent (eDRAM core 130) knows that the writeback data will follow.

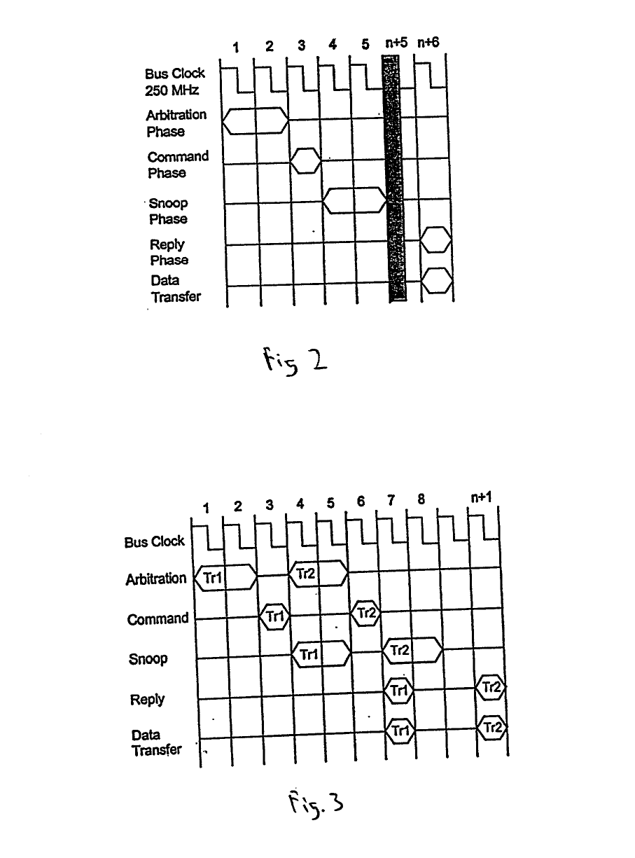

FIG. 2 illustrates several system bus 110 transaction phases for a non-split transaction with data transfer in accordance with one embodiment of the present invention. The system bus 110 contains all or some of the following five phases. In the split transaction mode, some of the phases can be overlapped: Arbitration Phase; Command Phase; Snoop Phase; Reply Phase; and Data Phase. As shown in FIG. 2, clock cycles 1 and 2 show the arbitration for system bus 110. Clock cycle 3 shows the command phase. Clock cycle 4 and 5 show the snoop phase. The latency of eDRAM core 130 is shown as “n” and the reply phase and the data transfer phase are shown in clock cycle n+6.

The transaction shown in FIG. 2 is for a read transaction from on chip memory (e.g., eDRAM core 130). This read transaction is based on an assumption that the start of the speculative access of memory (eDRAM core 130) is as soon as the address is available on system bus 110, and access time of memory (from the address on the bus to data ready for the bus) is 3 bus clock cycles (e.g., 12 ns), wherein “n” of FIG. 2 equals 1. Additionally, total time for a read transaction from eDRAM core 130 (e.g., from the start of bus arbitration to data availability on the bus) is 7 bus clock cycles.

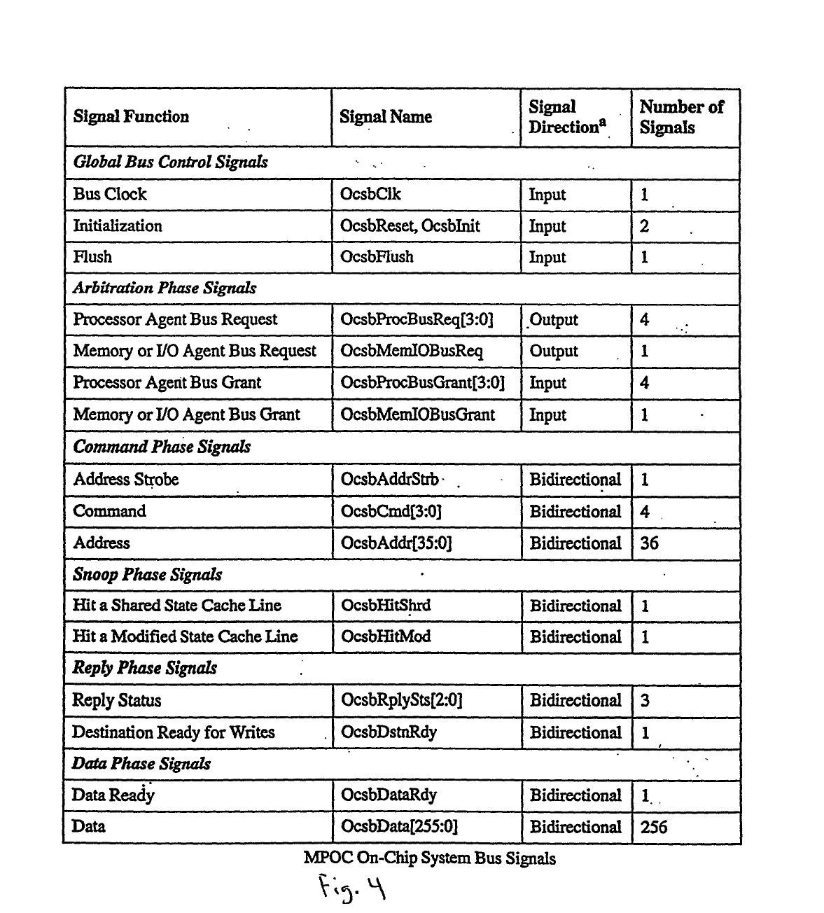

FIG. 3 shows several bus transaction phases for a split transaction data transfer in accordance with one embodiment of the present invention. FIG. 3 is similar to FIG. 2 with respect to the phases depicted. However, FIG. 3 shows a split data transaction with the first transaction shown as Tr1 and the second transaction shown as Tr2. As with FIG. 2, FIG. 3 shows reads from eDRAM core 130.

Referring still to FIGS. 2 and 3, it should be noted that both transactions have a Snoop Phase, two clock cycles away from the command phase. The Snoop Phase results indicate if the address driven for a transaction references a shared or modified cache line in any processor core's cache (e.g., caches 111-115). Both transactions have a Reply Phase. The Reply Phase indicates whether the transaction has failed or succeeded, and whether the transaction contains a Data Phase. If the transaction does not have a Data Phase, the transaction is complete after the Replay Phase. If the requesting agent has write data to transfer or is requesting read data, the transaction has a Data Phase which may extend beyond the replay phase.

It should be noted that not all transactions contain all phases, and some phases can be overlapped. For example, the Arbitration Phase needs to occur only if the agent that is driving the transaction does not already own the bus. The Data Phase occurs only if a transaction requires a data transfer. The Reply Phase overlaps with the Data Phase for read transactions, and the Reply Phase triggers the Data Phase for write transactions.

In addition, since system bus 110 supports split transactions with bus transaction pipelining, phases from one transaction can overlap phases from another transaction, as illustrated in FIG. 3.

In one embodiment, system bus 110 supports four outstanding split transactions, wherein bus transactions in different phases overlap, simultaneously. In order to track split transactions, the agents connected to system bus 110 need to track certain transaction information, such as the number of transactions outstanding, the transaction to be snooped next, and the transaction to receive a reply next.

This information is tracked in a queue called an In-Order-Queue (IOQ). All agents connected to system bus 110 maintain identical IOQ status to track every transaction that is issued to the system bus 110. When a transaction is issued to the bus, it is also entered in the IOQ of each agent. In this embodiment, the depth of IOQs in each of the agents is four, and this is the limit of how many transactions ca be outstanding on system bus 110 simultaneously. Because transactions receive their replies and data in the same order as they were issued, the transaction at the top of the IOQ is the next transaction to enter the Reply and Data Phases. A transaction is removed from the IOQ after the Reply Phase is complete.

For tracking split transactions, besides those listed above, other agent specific bus information also needs to be tracked. It should be noted that each agent needs to track all of this additional information. Examples of additional information to be tracked are now listed. A Request agent needs to track whether a transaction is a read or a write, and whether this agent has to provide or accept data during the transaction. A Reply agent has to track whether it owns the reply for the transaction at the top of the IOQ. It also has to know if this transaction contains an implicit writeback data and whether this agent has to receive the writeback data. A Reply agent also needs to know, if the transaction is a read, whether this agent owns the data transfer, and if the transaction is a write, whether this agent accepts the data. A Snooping agent has to track if the transaction needs to be snooped, and if this transaction contains an implicit writeback data to be supplied by this agent. It should be noted that the above transaction information can be tracked by separate smaller queues or by one wide IOQ.

The system bus 110 supports the following types of bus transactions: Read and write a cache line; Read and write 1, 2, or 4 bytes in an aligned 4-byte span; Read and write multiple 4-byte spans; Read a cache line and invalidate in other caches; Invalidate a cache line in other caches; I/O read and writes; Interrupt Acknowledge; and Special transactions, that are used to send various messages on the bus, such as, Flush, Flush Acknowledge etc.

The system bus 110 distinguishes between memory and I/O transactions. Memory transactions are used to transfer data to and from the on-chip eDRAM memory 130. Memory transactions address memory using the full width of the address bus. A processor core (e.g., one of processor cores 101-105) can address up to 64 GBytes of physical memory. I/O transactions are used to transfer data to and from the I/O address space. The system bus 110 distinguishes between different data transfer lengths, as described in the following discussions.

With respect to cache line transfers across system bus 110, a cache line transfer reads or writes a cache line, the unit of caching in a CMP system 100. On system bus 110, this is 32 bytes aligned on a 32 byte boundary. The system bus 110 is capable of transferring a full cache line in one bus clock cycle.

With respect to Partial Transfers on system bus 110, a part-line transfer moves a quantity of data smaller than a full cache line, but 1, 2, or 4 bytes in an aligned 4-byte span.

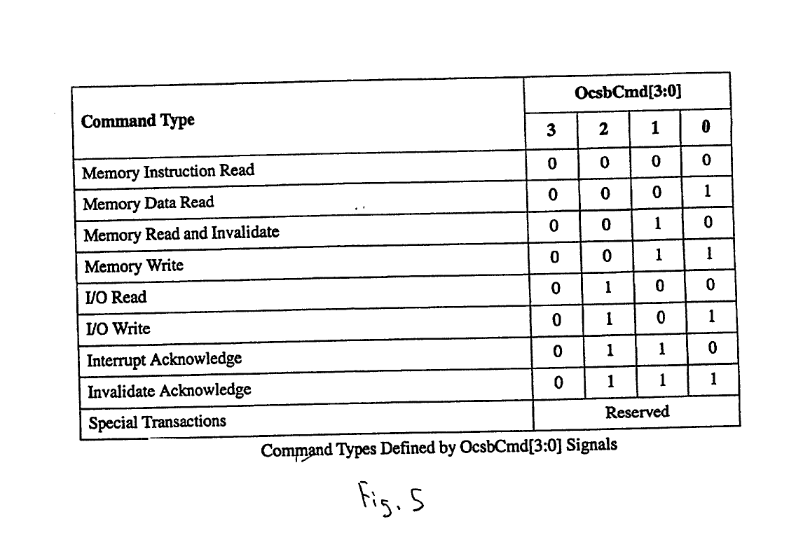

FIG. 4 shows a table of the signal functions of the system bus 110 in accordance with one embodiment of the present invention. In the table of FIG. 4, the signals are grouped according to function. All shown signals are active high, and the signal directions are with respect to the bus agents, unless specified otherwise.

The following signals are Global Bus Control Signals. OcsbClk input signal is the basic clock for the system bus 100. All agents drive their outputs and latch their inputs on the OcsbClk rising edge. OcsbReset input signal resets all bus agents to known states and invalidates their internal caches. Modified cache lines are not written back. On observing active OcsbReset, all bus agents must deassert their outputs within two bus clock cycles. OcsbInit input signal resets all bus agents without affecting their internal caches. If the OcsbFlush input signal is asserted, bus agents write back to the memory all internal cache lines in the Modified state, and invalidate all internal cache lines. The flush operation puts all internal cache lines in the Invalid state. After all lines are written back and invalidated, the bus agents drive a special transaction, the Flush Acknowledge Transaction, to indicate the completion of the flush operation.

The following signals are Arbitration Phase Signals. Arbitration Phase Signals are is used to arbitrate for the system bus 110. In one embodiment, up to five agents can simultaneously arbitrate for the system bus 110. For example, four or more symmetric processor core agents using the OcsbProcBusReq[3:0] signals, and one of the memory or I/O agents using the OcsbMemIOBusReq signal. Owning the bus is a necessary condition for a bus agent to initiate a bus transaction.

One to four processor agents, by asserting their respective OcsbProcBusReq[n] signal, arbitrate as symmetric bus agents. The symmetric agents arbitrate for the system bus 110 based on a round-robin rotating priority scheme. The arbitration is fair and symmetric. After reset, agent 0 has the highest priority followed by agents 1, 2, and 3.

The memory or I/O bus agent, by asserting the OcsbMemIOBusReq signal, arbitrates as a priority bus agent on behalf of the memory or I/O subsystem. The assertion of the OcsbMemIOBusReq signal temporarily overrides, but does not otherwise alter the symmetric arbitration scheme. When OcsbMemIOBusReq is sampled active, no symmetric processor agent issues another bus transaction until OcsbMemIOBusReq is sampled inactive. The memory or I/O bus agent is always the next owner of system bus 110.

MPOC system 100 uses a centralized arbiter for the system bus 110. The central system bus 110 arbiter informs the processor winning the arbitration by asserting its respective OcsbProcBusGrant [n] signal. The central system bus 110 arbiter informs the memory or I/O bus agent when it owns the bus by asserting the OcsbMemIOBusGrant signal.

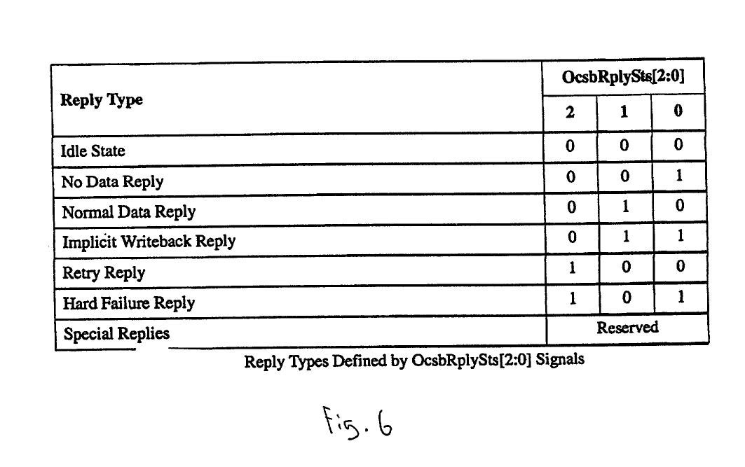

FIG. 5 shows a table of a set of Command Phase Signals in accordance with one embodiment of the present invention. The command signals transfer request information, including the transaction address. A Command Phase is one bus clocks long, beginning with the assertion of the OcsbAddrStrb signal. The assertion of the OcsbAddrStrb signal defines the beginning of the Command Phase. The OcsbCmd[3:O] and OcsbAddr[35:O] signals are valid in the clock that OcsbAddrStrb is asserted. The OcsbCmd[3:0] identify the transaction type as shown in FIG. 5.

With respect to Snoop Phase signals, the snoop signal group provides snoop result information to the system bus 110 agents in the Snoop Phase. The Snoop Phase starts one bus clock after a transaction's Command Phase begins (1 bus clocks after OcsbAddrStrb is asserted), or the second clock after the previous snoop results, whichever is later. On observing a Command Phase (OcsbAddrStrb active) for a memory access, all caching agents are required to perform an internal snoop operation and appropriately return OcsbHitShrd or OcsbHitMod in the Snoop Phase. OcsbHitShrd and OcsbHitMod signals are used to indicate that the cache line is valid or invalid in the snooping agent, and whether the line is in the modified (dirty) state in the caching agent. The OcsbHitShrd and OcsbflitMod signals are used to maintain cache coherency at the CMP system 100 chip level. A caching agent must assert OcsbHitShrd and deassert OcsbHitMod in the Snoop Phase if the agent plans to retain the line in its cache after the snoop. Otherwise, OcsbHitShrd signal should be deasserted.

The requesting agent determines the highest permissible cache state of the line using the OcsbHitShrd signal. If OcsbHitShrd is asserted, the requester may cache the line in the Shared state. If OcsbHitShrd is deasserted, the requester may cache the line in the Modified state. Multiple caching agents can assert OcsbHitShrd in the same Snoop Phase. A snooping agent asserts OcsbHitMod if the line is in the Modified state in its cache. After asserting OcsbHitMod, the agent assumes the responsibility for writing back the modified line during the Data Phase (this is called implicit write back). The memory agent must observe the OcsbHitMod signal in the Snoop Phase. If the memory agent observes OcsbHitMod active, it relinquishes responsibility for the data return and becomes a destination for the implicit writeback. The memory agent must merge the cache line being written back with any the write data and update memory. The memory agent must also provide the implicit writeback reply for the transaction to the system bus 110. Assertion of OcsbHitShrd and OcsbHitMod signals together is prohibited.

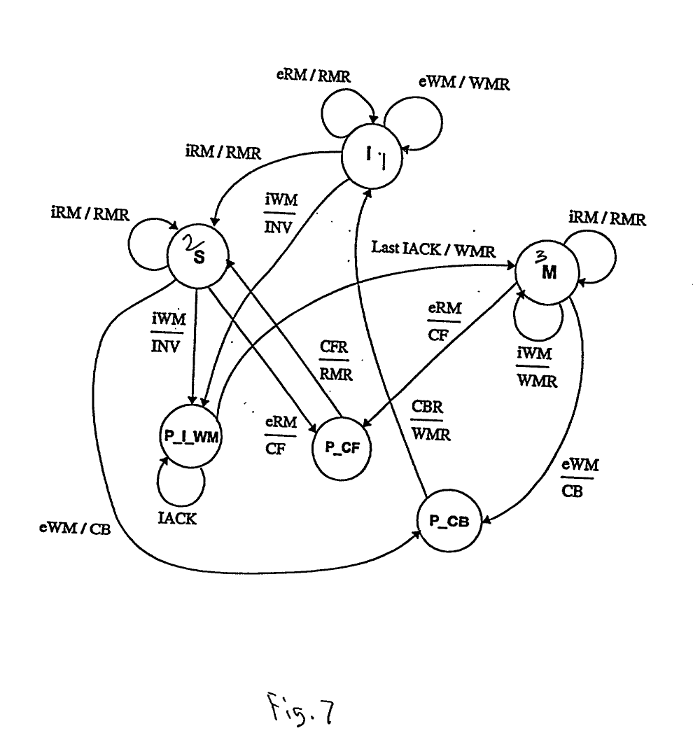

FIG. 6 shows a table of a set of Reply Phase signals in accordance with one embodiment of the present invention. The reply signal group provides reply information to the requesting agent in the Reply Phase of the system bus 110. The Reply Phase of a transaction occurs after the Snoop Phase of the same transaction. In the split-transaction mode, it occurs after the Reply Phase of a previous transaction. Also in the split-transaction mode, if the previous transaction includes a data transfer, the data transfer of the previous transaction must be completed before the Reply Phase for the new transaction is entered. Requests initiated in the Command Phase enter the In-Order Queue (IOQ), which is maintained by every system bus agent. The reply agent (the agent addressed by a transaction) is the agent responsible for completing the transaction at the top of the IOQ.

For write transactions, OcsbDstnRdy signal is asserted by the reply agent to indicate that it is ready to accept write or writeback data. For write transactions with an implicit writeback, OcsbDstnRdy is asserted twice, first for the write data transfer and then again for the implicit writeback data transfer. The reply agent asserts the OcsbRplySts[2:0] signals to indicate one of the transaction replies listed in the Table 3 above.

With respect to data phase signals, the data phase signals group contains the signals driven in the Data Phase of the system bus 110. Some system bus transactions do not transfer data and hence have no Data Phase. A Data Phase on the system bus 110 consists of one bus clock of actual data being transferred (a 32 byte cache line takes one bus clock cycle to transfer on the 256-bit bus). Read transactions have zero or one Data Phase. Write transactions have zero, one or two Data Phases. The OcsbDataRdy signal indicates that valid data is on the bus and must be latched. The OcsbData[255:0] signals provide a 256-bit data path between bus agents.

The system bus 110 cache coherency protocols, messages, and transactions are now described. The system bus 110 supports multiple caching agents (processor cores) executing concurrently. The cache protocol's goals include coherency with simplicity and performance. Coherency (or data consistency) guarantees that a system with caches and memory and multiple levels of active agents presents a shared memory model in which no agents ever reads stale data and actions can be serialized as needed.

A cache line is the unit of caching. In system 100, a cache line is 32 bytes of data or instructions, aligned on a 32-byte boundary in the physical address space. A cache line can be identified with the address bits OcsbAddr[35:0]. The cache coherency protocol associates states with cache lines and defines rules governing state transitions. States and state transitions depend on both system 100 processor core generated activities and activities by other bus agents (including other processor cores and on-chip eDRAM).

With respect to cache line states, each cache line has a state in each cache. In the system bus cache coherency protocol, there are three primary cache line states, M (Modified), S (Shared, and I (Invalid). A memory access to a (read or write) to a line in a cache can have different consequences depending on whether it is an internal access by the processor core, or an external access by another processor core on the system bus 110 or the eDRAM core 130.

The three primary cache line states are defined as follows:

I (Invalid): The line is not available in this cache. An internal access to this line misses the cache and will cause the processor core to fetch the line from the system bus 110 (from eDRAM 130 or from another cache in another processor core).

S (Shared): The line is in the cache, contains the same value as in memory, and can have the Shared state in other caches. Internally reading the line causes no bus activity. Internally writing the line causes an Invalidate Line transaction on the to gain ownership of the line.

M (Modified): The line is in this cache, contains a more recent value than memory, and is Invalid in all other caches. Internally reading or writing the line causes no bus activity.

The cache coherency protocols of system 100 are now described. With respect to coherency protocol cache line states, besides the three primary states defined in the subsection above, the cache coherency protocol of the present invention defines three more intermediate pending states, which are:

P_I_WM (Pending.invalidate_WriteMiss): The line is in a pending state, which is waiting to collect all Invalidate Acknowledgments from other caching agents on the system bus 110. A line enters this state in the case of an internal or external write miss. Once all Invalidate Acknowledgments are received, this state transitions over to the Modified state, so that the write can proceed.

P_CB (PendingCopyBack): The line is in a pending state, which is waiting for a Copy Back Reply message. A line enters this state in the case of a writeback (copy back) due to an external write miss. Once the Copy Back Reply message is received, this state transitions over to the Invalid state, indicating the absence of an internal copy of the cache line.

P_CF (Pending..CopyForward): The line is in a pending state, which is waiting for a Copy Forward Reply message. A line enters this state in the case of a cache to cache transfer (copy forward) due to an external read miss. Once the Copy Forward Reply message is received, this state transitions over to the Shared state, indicating a read-only internal copy of the line.

The three pending states are used by the coherency protocol to prevent any race conditions that may develop during the completion of coherency bus transactions. The pending states, in effect, lock out the cache line whose state is in transition between two primary states, thus ensuring coherency protocol correctness.

FIG. 7 shows a state transition diagram depicting the transitions between the states in accordance with the cache coherency protocols. FIG. 7 illustrates the coherency protocol state transitions between all primary and pending states, for all internal and external requests, with appropriate replies. With respect to coherency protocol messages depicted in FIG. 7, the CMP system 100 cache coherency protocol uses the following messages while transitioning between the shown cache line states:

iRM (internal Read Miss): Request due to an internal read miss.

eRM (external Read Miss): Request due to an external read miss.

RMR (Read Miss Reply): Reply for a read miss request (internal or external).

iWM (internal Write Miss): Request due to an internal write miss.

eWM (external Write Miss): Request due to an external write miss.

WMR (Write Miss Reply): Reply for a write miss request (internal or external).

INV (Invalidate): Request to invalidate a cache line.

IACK (Invalidate Ack): Acknowledgment of a completed invalidation.

CB (Copy Back): Request for copy back (i.e. writeback to memory).

CBR (Copy Back Reply): Reply indicating completion of copy back.

CF (Copy Forward): Request for copy forward (i.e. cache to cache transfer).

CFR (Copy Forward Reply) Reply indicating completion of copy forward.

With respect to coherency memory types, within system 100, each cache line has a memory type determined by the processor core. For caching purposes, the memory type can be writeback (WE), write-through (WT), write-protected (WP), or un-cacheable (UC). A WB line is cacheable and is always fetched into the cache on a write miss. A write to a WB line does not cause bus activity if the line is in the M state. A WT line is cacheable but is not fetched into the cache on a write miss. A write to a WT line goes out on the bus. A WP line is also cacheable, but a write to it cannot modify the cache line and the write always goes out on the bus. A WP line is not fetched into the cache on a write miss. An UC line is not put into the cache.

With respect to coherency bus transactions, system bus 110 coherency transactions are classified into the following generic groups:

ReadLine—A system bus Read Line transaction is a Memory Read Transaction for a full cache line. This transaction indicates that a requesting agent has had a read miss.

ReadPartLine—A system bus Read Part Line transaction indicates that a requesting agent issued a Memory Read Transaction for less than a full cache line.

WriteLine—A system bus Write Line transaction indicates that a requesting agent issued a Memory Write Transaction for a full cache line. This transaction indicates that a requesting agent intends to write back a Modified line.

WritePartLine—A system bus Write Part Line transaction indicates that a requesting agent issued a Memory Write Transaction for less than a full came line.

ReadlnvLine—A system bus Read Invalidate Line transaction indicates that a requesting agent issued a Memory (Read) Invalidate Line Transaction for a full cache line. The requesting agent has had read miss and intends to modify this line when the line is returned.

InvLine—A system bus Invalidate Line transaction indicates that a requesting agent issued a Memory (Read) Invalidate Transaction for 0 bytes. The requesting agent contains the line in S state and intends to modify the line. In case of a race condition, the reply for this transaction can contain an implicit writeback.

Impl WriteBack—A system bus Implicit WriteBack is not an independent bus to transaction. It is a reply to another transaction that requests the most up-to-date data. When an external request hits a Modified line in the local cache or buffer, an implicit writeback is performed to provide the Modified line and at the same time, update memory.

Thus the high performance system bus architecture for a single chip multiprocessor integrated circuit device of the present invention provides the advantages of CMP systems with respect to increasing computer system performance, but avoids the problems, such as memory management overhead problems. The present invention provides an efficient interconnection mechanism for CMP systems having embedded memory. Additionally, the present invention provides a CMP system architecture that provides low latency, high throughput operation with efficient management of dedicated processor cache memory and embedded DRAM.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order best to explain the principles of the invention and its practical application, thereby to enable others skilled in the art best to utilize the invention and various embodiments with various modifications as are suited to the particular use contemplated. It is intended that the scope of the invention be defined by the claims appended hereto and their equivalents.

What is claimed is:

1. A cache coherent multiple processor integrated circuit, comprising:
a plurality of processor units;
a plurality of cache units, one of the cache units provided for each one of the processor units;
an embedded RAM unit for storing instructions and data for the processor units;
a cache coherent bus coupled to the processor units and the embedded RAM unit, the bus configured to provide cache coherent snooping commands from the processor units to ensure cache coherency between the cache units for the processors and the embedded RAM unit.

2. The circuit of claim 1, further comprising an input output unit coupled to the bus to provide input and output transactions for the processor units.

3. The circuit of claim 1, wherein the bus is configured to provide split transactions for the processor units coupled to the bus.

4. The circuit of claim 1, wherein the bus is configured to transfer an entire cache line for the cache units of the processor units.

5. The circuit of claim 1, wherein the bus is 256 bits wide.

6. The circuit of claim 1, wherein the RAM unit is an embedded DRAM core.

7. The circuit of claim 1, wherein the bus is configured to support a symmetric multiprocessing method for the plurality of processor units.

8. The circuit of claim 1, wherein the processor units are compatible with a version of a MIPS processor core.

9. The circuit of claim 1, wherein the processor units are configured to provide read data via the bus when the read data is stored within a respective cache unit.

10. An integrated circuit device, comprising:
an integrated circuit die; and
a power supply coupled to the integrated circuit die, wherein the integrated circuit die includes therein:
a plurality of processor units;
a plurality of cache units, one of the cache units provided for each one of the processor units;
an embedded RAM unit for storing instructions and data for the processor units;
a cache coherent bus coupled to the processor units and the embedded RAM unit, the bus configured to provide cache coherent snooping commands from the processor units to ensure cache coherency between the cache units for the processor units and the embedded RAM unit.

11. The circuit of claim 10, further comprising an input output unit coupled to the bus to provide input and output transactions for the processor units.

12. The circuit of claim 10, wherein the bus is configured to provide split transactions for the processor units coupled to the bus.

13. The circuit of claim 10, wherein the bus is configured to transfer an entire cache line for the cache units of the processor units.

14. The circuit of claim 10, wherein the bus is 256 bits wide.

15. The circuit of claim 10, wherein the RAM unit is an embedded DRAM core.

16. The circuit of claim 10, wherein the bus is configured to support a symmetric multiprocessing method for the plurality of processor units.

17. The circuit of claim 10, wherein the processor units are compatible with a version of a MIPS processor core.

18. The circuit of claim 10, wherein the processor units are configured to provide read data via the bus when the read data is stored within a respective cache unit.

19. A portable hand-held electronic device, comprising:
an integrated circuit die; and
a power supply coupled to the integrated circuit die, wherein the integrated circuit die includes therein:
a plurality of processor units;
a plurality of cache units, one of the cache units provided for each one of the processor units;
an embedded DRAM core unit for storing instructions and data for the processor units;
a 256 bit cache coherent bus coupled to the processor units and the embedded DRAM core unit, the bus configured to provide cache coherent snooping commands from the processor units to ensure cache coherency between the cache units for the processor units and the embedded DRAM core unit.

20. The circuit of claim 19, wherein the bus is configured to provide split transactions for the processor units coupled to the bus.
